(19) United States
(12) Patent Application Publication
(10) Pub. No.: US 2015/0049072 A1
(43) Pub. Date: Feb. 19, 2015

(54) METHOD AND APPARATUS FOR TESTING A DIGITAL DISPLAY

(71) Applicant: SANOFI-AVENTIS DEUTSCHLAND GMBH, Frankfurt am Main (DE)

(72) Inventors: Ilona Eggert, Frankfurt am Main (DE); Michael Caspers, Frankfurt am Main (DE); Shane Alistair Day, Warwickshire (GB)

(21) Appl. No.: 14/389,555

(22) PCT Filed: Apr. 4, 2013
(86) PCT No.: PCT/EP2013/057126

§ 371 Date: Sep. 30, 2014

(30) Foreign Application Priority Data
Apr. 4, 2012 (DE) 12163243.4

(51) Int. Cl. G09G 3/00

(52) U.S. Cl. CPC G09G 3/006
USPC 345/211

(57) ABSTRACT

The invention is related to a method comprising applying a voltage to a digital display module, detecting an electrical quantity related to the digital display module, determining whether the detected electrical quantity is indicative of correct operation of the digital display module. The invention is further related to a system for interfacing to a display, comprising an electrical input output arrangement configured to apply a voltage to a digital display module, configured to detect an electrical quantity related to the digital display module and configured to determine whether the detected electrical quantity is indicative of correct operation of the digital display module and configured to determine whether the detected electrical quantity is indicative of correct operation of the digital display module.

### CROSS REFERENCE TO RELATED APPLICATIONS

The present application is a U.S. National Phase Application pursuant to 35 U.S.C. §371 of International Application No. PCT/EP2013/057126 filed Apr. 4, 2013, which claims priority to European Patent Application No. 12163243.4 filed Apr. 4, 2012. The entire disclosure contents of these applications are herewith incorporated by reference into the present application.

### TECHNICAL FIELD

The present patent application relates to a method and apparatus for testing a digital display, especially to a method and apparatus for testing a digital display of a medical device for delivering a medicament.

### BACKGROUND

Medical devices for delivering a medicament, i.e. drug delivery devices, are often electronic devices and therefore regularly comprise a digital display. The digital display is part of the user interface of the medical device and is important, for example to permit the user to set the correct dosage of the medicament to be delivered.

There are various devices for delivering one or more drug agents from separate reservoirs. Such drug agents may comprise one or more medicaments. Such a medical device includes a dose setting mechanism for delivering the drug agent(s) automatically or manually by the user.

The medical device can be an injector, for example a hand-held injector, especially a pen-type injector, that is an injector of the kind that provides for administration by injection of medicinal products from one or more multidose cartridges. In particular, the present invention relates to such injectors where a user may set the dose.

The drug agent(s) may be contained in one or more multiple dose reservoirs, containers or packages containing independent (single drug compound) or pre-mixed (co-formulated multiple drug compounds) drug agent(s).

Certain disease states require treatment using one or more different medicaments. Some drug compounds need to be delivered in a specific relationship with each other in order to deliver the optimum therapeutic dose. The present patent application is of particular benefit where combination therapy is desirable, but not possible in a single formulation for reasons such as, but not limited to, stability, compromised therapeutic performance and toxicology.

For example, in some cases it may be beneficial to treat a diabetic with a long acting insulin (also may be referred to as the first or primary medicament) along with a glucagon-like peptide-1 such as GLP-1 or GLP-1 analog (also may be referred to as the second drug or secondary medicament).

Accordingly, there exists a need to provide devices for the delivery of two or more medicaments in a single injection or delivery step that is simple for the user to perform without complicated physical manipulations of the drug delivery device. The proposed drug delivery device provides separate storage containers or cartridge retainers for two or more active drug agents. These active drug agents are then combined and/or delivered to the patient during a single delivery procedure. These active agents may be administered together in a combined dose or alternatively, these active agents may be combined in a sequential manner, one after the other.

The drug delivery device also allows for the opportunity of varying the quantity of the medicaments. For example, one fluid quantity can be varied by changing the properties of the injection device (e.g., setting a user variable dose or changing the device's “fixed” dose). The second medicament quantity can be changed by manufacturing a variety of secondary drug containing packages with each variant containing a different volume and/or concentration of the second active agent.

The drug delivery device may have a single dispense interface. This interface may be configured for fluid communication with a primary reservoir and with a secondary reservoir of medicament containing at least one drug agent. The drug dispense interface can be a type of outlet that allows the two or more medicaments to exit the system and be delivered to the patient.

The combination of compounds from separate reservoirs can be delivered to the body via a double-ended needle assembly. This provides a combination drug injection system that, from a user's perspective, achieves drug delivery in a manner that closely matches the currently available injection devices that use standard needle assemblies. One possible delivery procedure may involve the following steps:

1. Attach a dispense interface to a distal end of the electro-mechanical injection device. The dispense interface comprises a first and a second proximal needle. The first and second needles pierce a first reservoir containing a primary compound and a second reservoir containing a secondary compound, respectively.

2. Attach a dose dispenser, such as a double-ended needle assembly, to a distal end of the dispense interface. In this manner, a proximal end of the needle assembly is in fluidic communication with both the primary compound and secondary compound.

3. Dial up/set a desired dose of the primary compound from the injection device, for example, via a graphical user interface (GUI).

4. After the user sets the dose of the primary compound, the micro-processor controlled control unit may determine or compute a dose of the secondary compound and preferably may determine or compute this second dose based on a previously stored therapeutic dose profile. It is this computed combination of medicaments that will then be injected by the user. The therapeutic dose profile may be user selectable. Alternatively, the user can dial or set a desired dose of the secondary compound.

5. Optionally, after the second dose has been set, the device may be placed in an armed condition. The optional armed condition may be achieved by pressing and/or holding an “OK” or an “Arm” button on a control panel. The armed condition may be provided for a predefined period of time during which the device can be used to dispense the combined dose.

6. Then, the user will insert or apply the distal end of the dose dispenser (e.g. a double ended needle assembly) into the desired injection site. The dose of the combination of the primary compound and the secondary compound (and potentially a third medicament) is administered by activating an injection user interface (e.g. an injection button).

Both medicaments may be delivered via one injection needle or dose dispenser and in one injection step. This offers a convenient benefit to the user in terms of reduced user steps compared to administering two separate injections.

A drug delivery device, described in more detail hereinafter, comprises a display as part of its user interface. Especially, for any electronic device, it is to be desired that the functionality of its display can be supervised. For a drug delivery device, the proper operation of the display is important at all times to ensure proper dosage of the medicament, because both insufficient delivery as well as delivery of an overdose can be dangerous to a user. The proper operation of the display of the electronic device should be ensured not only during production testing and before shipment, but also throughout the time that it is used by the user. The direct way of testing the proper operation of the digital display would be visual or camera inspection of the digital display, which obviously is not possible under normal user conditions.

### SUMMARY

It is an object of the invention to provide a way of continually testing the proper operation of an electronic device's display.

This object is solved by a method comprising: applying a voltage to a digital display module, detecting an electrical quantity related to the digital display module, and determining whether the detected electrical quantity is indicative of correct operation of the digital display module.

The method according to the invention thus permits testing of the digital display's functionality based only on the electrical interface of the digital display and without any action of the user of the device including the digital display.

The digital display module may comprise the display as well as auxiliary circuitry for interfacing to the display as well as supplying the display with power. The display may be either a color display or a monochrome display. The display may be a liquid crystal display (LCD). The display may also be a light emitting diode (LED) display, such as an organic light emitting diode (OLED) display.

The display is supplied with electrical power, preferably with a DC voltage, over one or more power supply lines.

The display is controlled by an electronic circuit designated as the display driver. The display driver can be contacted and addressed by a digital data link. The digital data link may be a serial peripheral interface bus, an inter-integrated circuit (I2C) bus or another appropriate digital communication link. The color, luminosity or other property of each pixel of the display is controlled by writing appropriate digital data to specific data addresses of the display driver. For example, bitmap image data may be written to the specific data addresses. The digital data may also be read from the display driver over the same digital data link.

Applying a voltage to the digital display module may comprise applying a signal via the digital data link to the display driver. In particular, it may comprise sending a digital message or command to the display driver. Applying a voltage to the digital display module may also comprise applying a DC voltage to the one or more power supply lines or applying a varying voltage to the one or more power supply lines.

Detecting an electrical quantity related to the digital display module may comprise detecting any electrical quantity, such as voltage or current, from any line of the digital display module, such as for example from the one or more power supply lines or the digital data link. The electrical quantity may be detected at one or more points in time or may be detected continually over one or more periods of time.

For example, detecting or measuring a current at one or more point in time may comprise measuring a current to the display when the display is switched off, for example when no pixel of the display is addressed, or when all pixels are black (or grey).

Further, detecting or measuring a current at one or more point in time may comprise measuring a current to the display when instructions to show one or more pattern are sent to the display, such as alternating black and write (or colored) lines, a checked pattern, and or the like. Such a pattern may also be a sequence of pixels. If one pixel in the sequence is faulty, the current may drop (or rise) at or during the time that this pixel is addressed.

Determining whether the detected electrical quantity is indicative of correct operation of the digital display module may comprise any processing, in particular any mathematical processing, of the detected electrical quantity which produces a positive, negative or inconclusive result indicative of correct operation of the digital display module. In particular, the determination may be based on the entire detected electrical quantity or on parts of the detected electrical quantity. Processing the detected electrical quantity may comprise averaging over a certain time, for example averaging a measured current or voltage over a cycle time of showing one or more patterns. Processing the detected electrical quantity may also comprise detecting or measuring a change of the electrical quantity, for example detecting a current change when switching from one pattern to another pattern, or when switching from one pattern to an “off”-state of the display. It may be that a detected electrical quantity which is either below a lower threshold or above an upper threshold or outside a given band is indicative of incorrect operation of the digital display module. By the same token, it may be that a detected electrical quantity which is above a lower threshold and below an upper threshold is indicative of correct operation of the digital display module.

The object is also solved by a system for interfacing to a digital display comprising an electrical input output arrangement configured to apply a voltage to a digital display module, configured to detect an electrical quantity related to the digital display module and configured to determine whether the detected electrical quantity is indicative of correct operation of the digital display module.

The electrical input output arrangement may comprise any number of separate entities. The electrical input output arrangement may also be part of a single device or unit. The functionality of the electrical input output arrangement may also be partially implemented in software.

The detection of the electrical quantity may be done by circuitry within the display driver. Such a display driver may also perform tests of a connected display when performing a self test. For example, the display driver may have a first self test mode for detecting any internal faults, and a second self test mode for detecting any fault in a connected display by performing any of the tests or measurements described in this text.

A preferred embodiment of the method is characterized in that applying a voltage to the digital display module comprises writing a display data into a display driver of the digital display module to at least one predetermined address. A preferred embodiment may further be characterized in that detecting an electrical quantity related to the digital display module comprises reading data out of the display driver from the at least one predetermined address. A preferred embodiment may further be characterized in that determining whether the detected electrical quantity is indicative of correct operation of the digital display module comprises determining whether reading the data out of the display driver was successful and determining whether the data read out of the display driver is identical to the display data written into the display driver.

It may be indicative of a malfunction of the display in general or the display driver in particular if either the read operation from the data addresses of the display driver is unsuccessful or if the data read from the display driver is not identical to the data previously written to the display driver at the same address or at the same addresses.

Another preferred embodiment of the method is characterized in that detecting an electrical quantity related to the digital display module comprises detecting a voltage level on at least one power supply line of a display driver of the digital display module and determining whether the detected electrical quantity is indicative of correct operation of the digital display module comprises determining whether the detected voltage level is below a voltage threshold.

The display is supplied with electrical power from an external power supply. If any power supply line does not provide sufficient voltage, the display may not function properly. Therefore insufficient voltage on any power supply line is indicative of a malfunction of the display. A voltage which is below a voltage threshold may also be indicative of a short circuit to ground or of excessive leakage current to ground.

Yet another preferred embodiment of the method is characterized in that detecting an electrical quantity related to the digital display module comprises detecting a current supplied to the display driver and determining whether the detected current is indicative of correct operation of the digital display module comprises determining whether the detected current is indicative of correct display driver operation.

The display consumes electrical power and therefore current when active. Therefore a current consumption which is outside the boundaries to be expected for normal operation is indicative of malfunction. Too low or none-existing current consumption may be indicative of lack of activation whereas an increased current consumption may be indicative of a short-circuit condition.

A yet further preferred embodiment of the method is characterized in that the display data is a test display data, which can be predetermined display data or randomly generated display data. This means that the test display data to be written to the display driver has already been determined before the actual test commences.

Yet another preferred embodiment of the method is characterized in that determining whether the detected current is indicative of correct display driver operation comprises comparing the detected current with a current threshold, which current threshold is based on the test display data.

The current consumed by the display depends on the operation of the display. Since the data written to the display driver determines the number of active pixels as well as their color and luminosity, the current consumption of the display may depend on the test display data. Therefore, the current associated with the correct operation of the display may be determined based on the test display data written to the display driver. The comparison with the current threshold may be such that correct operation is determined when the detected current is above the threshold and incorrect operation is determined when the detected current is below the threshold. Alternatively, the comparison with the current threshold may also be such that correct operation is determined when the detected current is below the threshold and incorrect operation is determined when the detected current is above the threshold.

If the display data is a predetermined test display data, then also the current threshold may be predetermined. In particular, it may be determined as a result of tests run in a lab or factory and then hardcoded into the algorithm for determining whether the detected electrical quantity is indicative of correct operation of the digital display module.

A preferred embodiment of the method is characterized in that determining whether the detected current is indicative of correct display driver operation comprises comparing the detected current to a current range which is based on the test display data. Instead of comparing the detected current with a threshold value, it may also be checked whether the detected current lies within a current range defined by a lower current boundary and an upper current boundary, which lower and upper boundary is calculated based on the test display data.

Using randomly generated test display data instead of predetermined test display data has the advantage of reducing the risk of undetected display driver malfunctions based on a systematic lack of coverage of fixed test display data. Any fixed test data does not cover all possible error situations. To avoid or minimize error conditions that are systematically not covered, either the number of test data sets can be increased to achieve a higher coverage or random test data may be used.

A preferred embodiment of the system is characterized in that the electrical input output arrangement comprises a test control unit configured to write a set of display data into a display driver of the digital display module to at least one predetermined address, configured to read data out of the display driver from the at least one predetermined address, configured to determine whether reading the data out of the display driver was successful, and configured to determine whether the data read out of the display driver is identical to the display data written into the display driver.

This embodiment has the advantage of enabling a test method using a comparison between the data written to and read from the display driver to prove whether or not the display is working correctly or not.

Another preferred embodiment of the system is characterized in that the electrical input output arrangement comprises a battery configured to supply a voltage on at least one power supply line of a display driver of the digital display module, a measuring unit configured to detect a voltage level on the least one power supply line and a test control unit configured to determine whether the detected voltage level is below a voltage threshold.

This embodiment is advantageous in that it enables to do a simple test by measuring the voltage supplied to the display and display driver. If the voltage does not lie within a predetermined range, a malfunction of the display is monitored.

A further preferred embodiment of the system is characterized in that the electrical input output arrangement comprises a battery configured to supply a voltage on at least one power supply line of a display driver of the digital display module, a measuring unit configured to detect a current supplied to the display driver and a test control unit configured to determine whether the detected current is indicative of correct display driver operation.

This embodiment has the advantage that the measured current can be compared with a predetermined threshold or range and if the measured current is lying out of the threshold or range, a malfunction of the display and display driver is detected.

### BRIEF DESCRIPTION OF THE FIGURES

These as well as other advantages of various aspects of the present invention will become apparent to those of ordinary skill in the art by reading the following detailed description, with appropriate reference to the accompanying drawings, in which:

FIG. 1 illustrates a perspective view of a delivery device with an end cap of the device removed;

FIG. 2 illustrates a perspective view of the delivery device distal end showing the cartridge;

FIG. 3 illustrates a perspective view of the delivery device illustrated in FIG. 1 or 2 with one cartridge retainer in an open position;

FIG. 4 illustrates a dispense interface and a dose dispenser that may be removably mounted on a distal end of the delivery device illustrated in FIG. 1;

FIG. 5 illustrates the dispense interface and the dose dispenser illustrated in FIG. 4 mounted on a distal end of the delivery device illustrated in FIG. 1;

FIG. 6 illustrates one arrangement of a needle assembly that may be mounted on a distal end of the delivery device;

FIG. 7 illustrates a perspective view of the dispense interface illustrated in FIG. 4;

FIG. 8 illustrates another perspective view of the dispense interface illustrated in FIG. 4;

FIG. 9 illustrates a cross-sectional view of the dispense interface illustrated in FIG. 4;

FIG. 10 illustrates an exploded view of the dispense interface illustrated in FIG. 4;

FIG. 11 illustrates a cross-sectional view of the dispense interface and needle assembly mounted onto a drug delivery device, such as the device illustrated in FIG. 1;

FIG. 12 illustrates a block diagram functional description of a control unit for operation of the drug delivery device illustrated in FIG. 4;

FIG. 13 illustrates a printed circuit board assembly of the drug delivery device illustrated in FIG. 4;

FIG. 14 illustrates a schematic view of a drive mechanism for use with the drug delivery device illustrated in FIG. 1

FIG. 15 illustrates a block diagram of a system according to the invention for testing the display of the drug delivery device illustrated in FIG. 1.

### DETAILED DESCRIPTION

Before explaining the invention, a medical device is described using a display as a user interface, wherein the current function of the display is important for a correct function of the whole device.

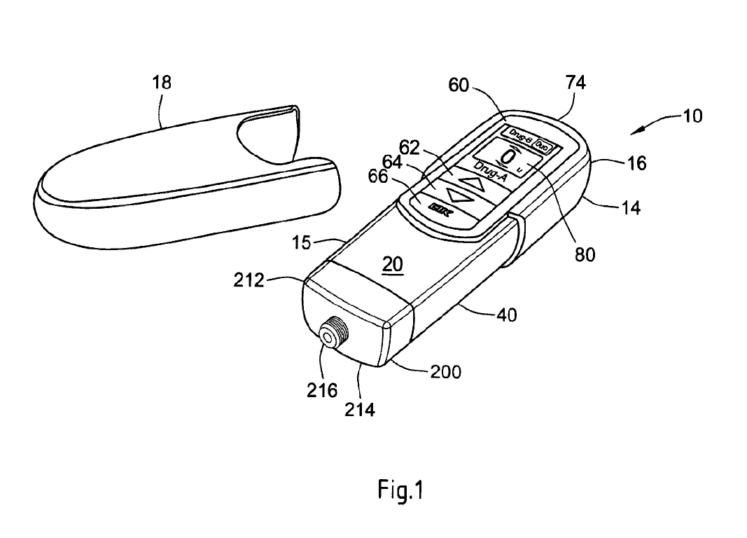

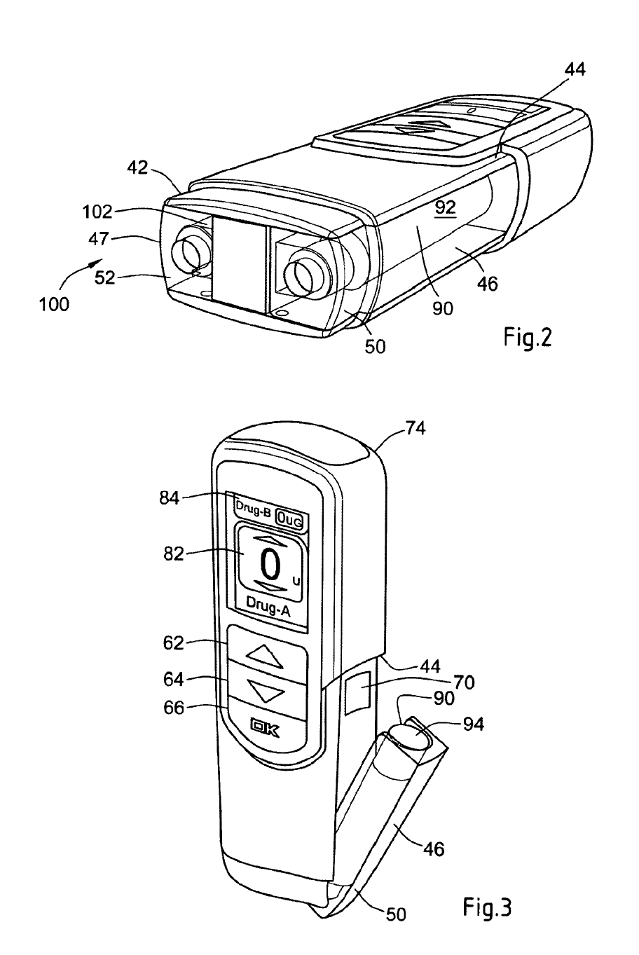

The drug delivery device illustrated in FIG. 1 comprises a main body 14 that extends from a proximal end 16 to a distal end 15. At the distal end 15, a removable end cap or cover 18 is provided. This end cap 18 and the distal end 15 of the main body 14 work together to provide a snap fit or form fit connection so that once the cover 18 is slid onto the distal end 15 of the main body 14, this frictional fit between the cap and the main body outer surface 20 prevents the cover from inadvertently falling off the main body.

The main body 14 contains a micro-processor control unit, an electro-mechanical drive train, and at least two medicament reservoirs. When the end cap or cover 18 is removed from the device 10 (as illustrated in FIG. 1), a dispense interface 200 is mounted to the distal end 15 of the main body 14, and a dose dispenser (e.g., a needle assembly) is attached to the interface. The drug delivery device 10 can be used to administer a computed dose of a second medicament (secondary drug compound) and a variable dose of a first medicament (primary drug compound) through a single needle assembly, such as a double ended needle assembly.

The drive train may exert a pressure on the bung of each cartridge, respectively, in order to expel the doses of the first and second medicaments. For example, a piston rod may push the bung of a cartridge forward a pre-determined amount for a single dose of medicament. When the cartridge is empty, the piston rod is retracted completely inside the main body 14, so that the empty cartridge can be removed and a new cartridge can be inserted.

A control panel region 60 is provided near the proximal end of the main body 14. Preferably, this control panel region 60 comprises a digital display 80 along with a plurality of human interface elements that can be manipulated by a user to set and inject a combined dose. In this arrangement, the control panel region comprises a first dose setting button 62, a second dose setting button 64 and a third button 66 designated with the symbol “OK.” In addition, along the most proximal end of the main body, an injection button 74 is also provided (not visible in the perspective view of FIG. 1).

The cartridge holder 40 can be removably attached to the main body 14 and may contain at least two cartridge retainers 50 and 52. Each retainer is configured so as to contain one medicament reservoir, such as a glass cartridge. Preferably, each cartridge contains a different medicament.

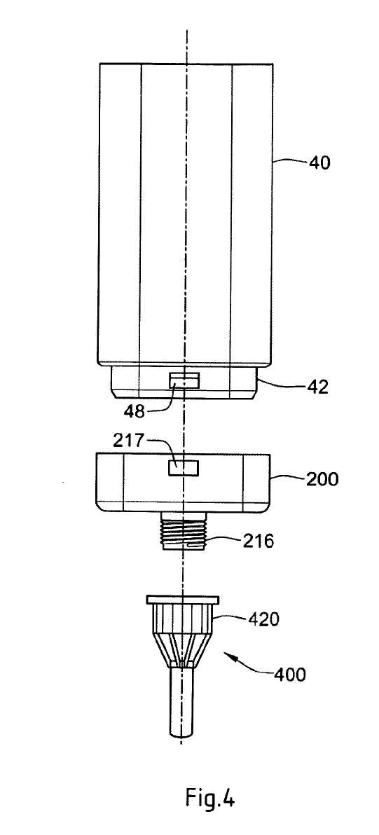

In addition, at the distal end of the cartridge holder 40, the drug delivery device illustrated in FIG. 1 includes a dispense interface 200. As will be described in relation to FIG. 4, in one arrangement, this dispense interface 200 includes a main outer body 212 that is removably attached to a distal end 42 of the cartridge housing 40. As can be seen in FIG. 1, a distal end 214 of the dispense interface 200 preferably comprises a needle hub 216. This needle hub 216 may be configured so as to allow a dose dispenser, such as a conventional pen type injection needle assembly, to be removably mounted to the drug delivery device 10.

Once the device is turned on, the digital display 80 shown in FIG. 1 illuminates and provides the user certain device information, preferably information relating to the medicaments contained within the cartridge holder 40. For example, the user is provided with certain information relating to both the primary medicament (Drug A) and the secondary medicament (Drug B).

As shown in FIG. 3, the first and second cartridge retainers 50, 52 may be hinged cartridge retainers. These hinged retainers allow user access to the cartridges. FIG. 3 illustrates a perspective view of the cartridge holder 40 illustrated in FIG. 1 with the first hinged cartridge retainer 50 in an open position. FIG. 3 illustrates how a user might access the first cartridge 90 by opening up the first retainer 50 and thereby having access to the first cartridge 90.

As mentioned above when discussing FIG. 1, a dispense interface 200 is coupled to the distal end of the cartridge holder 40. FIG. 4 illustrates a flat view of the dispense interface 200 unconnected to the distal end of the cartridge holder 40. A dose dispenser or needle assembly that may be used with the interface 200 is also illustrated and is provided in a protective outer cap 420.

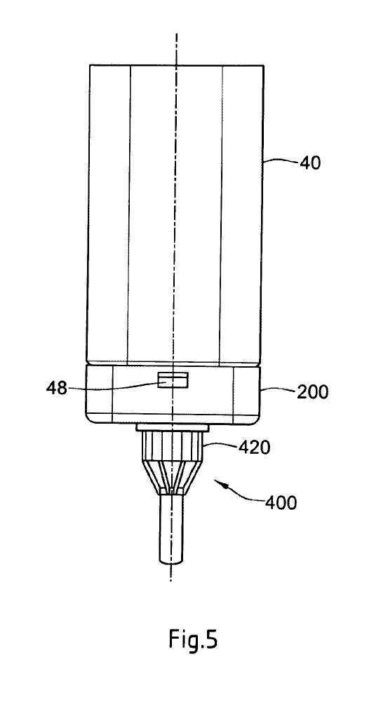

In FIG. 5, the dispense interface 200 illustrated in FIG. 4 is shown coupled to the cartridge holder 40. The axial attachment means between the dispense interface 200 and the cartridge holder 40 can be any known axial attachment means to those skilled in the art, including snap locks, snap fits, snap rings, keyed slots, and combinations of such connections. The connection or attachment between the dispense interface and the cartridge holder may also contain additional features (not shown), such as connectors, stops, splines, ribs, grooves, pips, clips and the like design features, that ensure that specific hubs are attachable only to matching drug delivery devices. Such additional features would prevent the insertion of a non-appropriate secondary cartridge to a non-matching injection device.

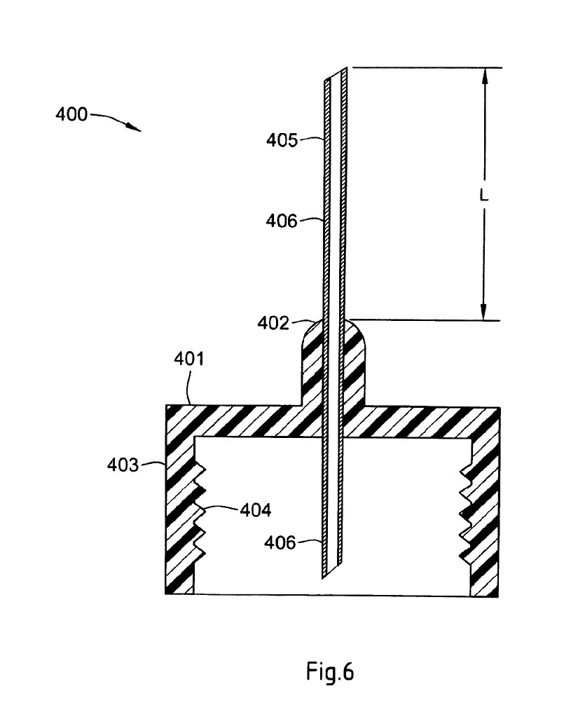

FIG. 5 also illustrates the needle assembly 400 and protective cover 420 coupled to the distal end of the dispense interface 200 that may be screwed onto the needle hub of the interface 200. FIG. 6 illustrates a cross sectional view of the double ended needle assembly 402 mounted on the dispense interface 200 in FIG. 5.

The needle assembly 400 illustrated in FIG. 6 comprises a double ended needle 406 and a hub 401. The double ended needle or cannula 406 is fixedly mounted in a needle hub 401. This needle hub 401 comprises a circular disk shaped element which has along its periphery a circumferential depending sleeve 403. Along an inner wall of this hub member 401, a thread 404 is provided. This thread 404 allows the needle hub 401 to be screwed onto the dispense interface 200 which, in one preferred arrangement, is provided with a corresponding outer thread along a distal hub. At a center portion of the hub element 401 there is provided a protrusion 402. This protrusion 402 projects from the hub in an opposite direction of the sleeve member. A double ended needle 406 is mounted centrally through the protrusion 402 and the needle hub 401. This double ended needle 406 is mounted such that a first or distal piercing end 405 of the double ended needle forms an injecting part for piercing an injection site (e.g., the skin of a user).

Similarly, a second or proximal piercing end 406 of the needle assembly 400 protrudes from an opposite side of the circular disc so that it is concentrically surrounded by the sleeve 403. In one needle assembly arrangement, the second or proximal piercing end 406 may be shorter than the sleeve 403 so that this sleeve to some extent protects the pointed end of the back sleeve. The needle cover cap 420 illustrated in FIGS. 4 and 5 provides a form fit around the outer surface 403 of the hub 401.

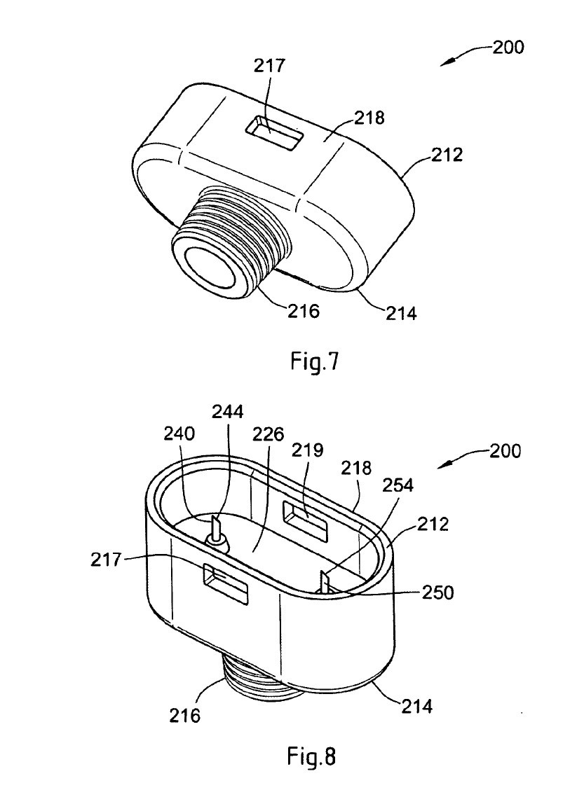

Referring now to FIGS. 4 to 11, one preferred arrangement of this interface 200 will now be discussed. In this one preferred arrangement, this interface 200 comprises:

a. a main outer body 210,

b. an first inner body 220,

c. a second inner body 230,

d. a first piercing needle 240,

e. a second piercing needle 250,

f. a valve seal 260, and

g. a septum 270.

The main outer body 210 comprises a main body proximal end 212 and a main body distal end 214. At the proximal end 212 of the outer body 210, a connecting member is configured so as to allow the dispense interface 200 to be attached to the distal end of the cartridge holder 40. Preferably, the connecting member is configured so as to allow the dispense interface 200 to be removably connected the cartridge holder 40. In one preferred interface arrangement, the proximal end of the interface 200 is configured with an upwardly extending wall 218 having at least one recess. For example, as may be seen from FIG. 8, the upwardly extending wall 218 comprises at least a first recess 217 and a second recess 219.

Preferably, the first and the second recesses 217, 219 are positioned within this main outer body wall so as to cooperate with an outwardly protruding member located near the distal end of the cartridge housing 40 of the drug delivery device 10. For example, this outwardly protruding member 48 of the cartridge housing may be seen in FIGS. 4 and 5. A second similar protruding member is provided on the opposite side of the cartridge housing. As such, when the interface 200 is axially slid over the distal end of the cartridge housing 40, the outwardly protruding members will cooperate with the first and second recess 217, 219 to form an interference fit, form fit, or snap lock. Alternatively, and as those of skill in the art will recognize, any other similar connection mechanism that allows for the dispense interface and the cartridge housing 40 to be axially coupled could be used as well.

The main outer body 210 and the distal end of the cartridge holder 40 act to form an axially engaging snap lock or snap fit arrangement that could be axially slid onto the distal end of the cartridge housing. In one alternative arrangement, the dispense interface 200 may be provided with a coding feature so as to prevent inadvertent dispense interface cross use. That is, the inner body of the hub could be geometrically configured so as to prevent an inadvertent cross use of one or more dispense interfaces.

A mounting hub is provided at a distal end of the main outer body 210 of the dispense interface 200. Such a mounting hub can be configured to be releasably connected to a needle assembly. As just one example, this connecting means 216 may comprise an outer thread that engages an inner thread provided along an inner wall surface of a needle hub of a needle assembly, such as the needle assembly 400 illustrated in FIG. 6. Alternative releasable connectors may also be provided such as a snap lock, a snap lock released through threads, a bayonet lock, a form fit, or other similar connection arrangements.

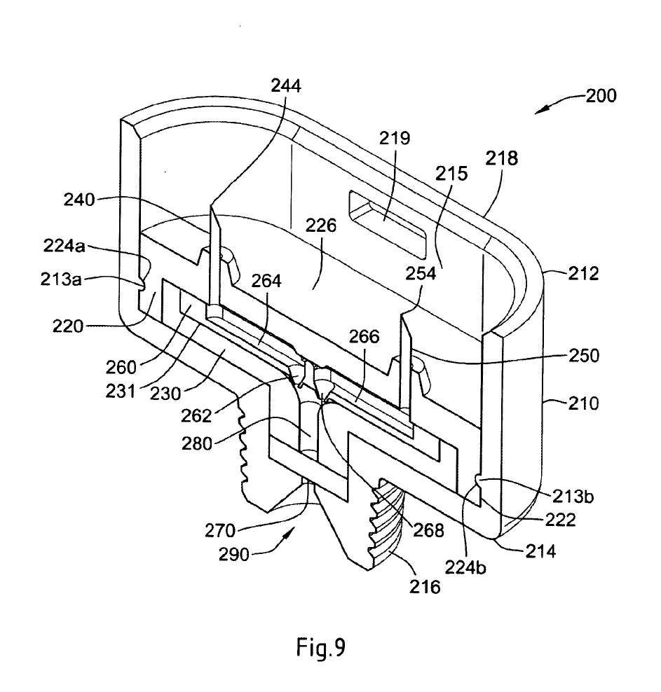

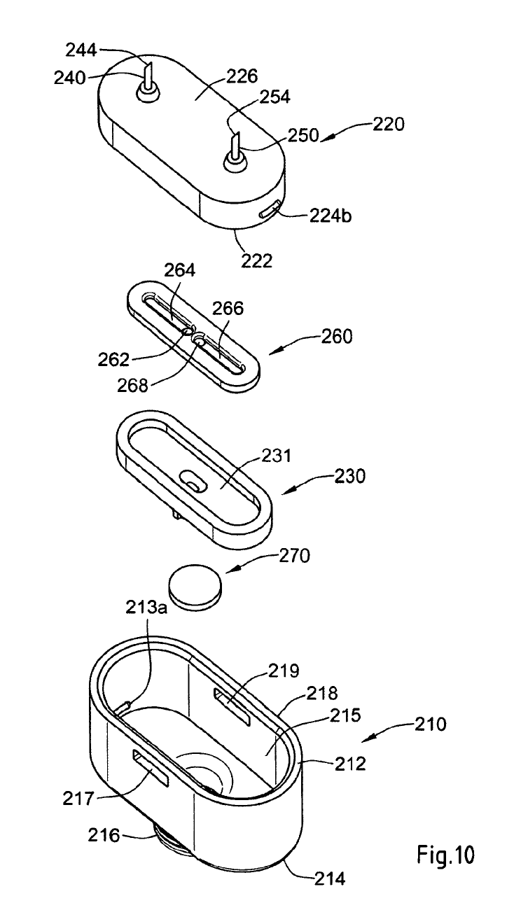

The dispense interface 200 further comprises a first inner body 220. Certain details of this inner body are illustrated in FIG. 8-11. Preferably, this first inner body 220 is coupled to an inner surface 215 of the extending wall 218 of the main outer body 210. More preferably, this first inner body 220 is coupled by way of a rib and groove form fit arrangement to an inner surface of the outer body 210. For example, as can be seen from FIG. 9, the extending wall 218 of the main outer body 210 is provided with a first rib 213a and a second rib 213b. This first rib 213a is also illustrated in FIG. 10. These ribs 213a and 213b are positioned along the inner surface 215 of the wall 218 of the outer body 210 and create a form fit or snap lock engagement with cooperating grooves 224a and 224b of the first inner body 220. In a preferred arrangement, these cooperating grooves 224a and 224b are provided along an outer surface 222 of the first inner body 220.

In addition, as can be seen in FIG. 8-10, a proximal surface 226 near the proximal end of the first inner body 220 may be configured with at least a first proximally positioned piercing needle 240 comprising a proximal piercing end portion 244. Similarly, the first inner body 220 is configured with a second proximally positioned piercing needle 250 comprising a proximally piercing end portion 254. Both the first and second needles 240, 250 are rigidly mounted on the proximal surface 226 of the first inner body 220.

Preferably, this dispense interface 200 further comprises a valve arrangement. Such a valve arrangement could be constructed so as to prevent cross contamination of the first and second medicaments contained in the first and second reservoirs, respectively. A preferred valve arrangement may also be configured so as to prevent back flow and cross contamination of the first and second medicaments.

In one preferred system, dispense interface 200 includes a valve arrangement in the form of a valve seal 260. Such a valve seal 260 may be provided within a cavity 231 defined by the second inner body 230, so as to form a holding chamber 280. Preferably, cavity 231 resides along an upper surface of the second inner body 230. This valve seal comprises an upper surface that defines both a first fluid groove 264 and second fluid groove 266. For example, FIG. 9 illustrates the position of the valve seal 260, seated between the first inner body 220 and the second inner body 230. During an injection step, this seal valve 260 helps to prevent the primary medicament in the first pathway from migrating to the secondary medicament in the second pathway, while also preventing the secondary medicament in the second pathway from migrating to the primary medicament in the first pathway. Preferably, this seal valve 260 comprises a first non-return valve 262 and a second non-return valve 268. As such, the first non-return valve 262 prevents fluid transferring along the first fluid pathway 264, for example a groove in the seal valve 260, from returning back into this pathway 264. Similarly, the second non-return valve 268 prevents fluid transferring along the second fluid pathway 266 from returning back into this pathway 266.

Together, the first and second grooves 264, 266 converge towards the non-return valves 262 and 268 respectively, to then provide for an output fluid path or a holding chamber 280. This holding chamber 280 is defined by an inner chamber defined by a distal end of the second inner body both the first and the second non return valves 262, 268 along with a pierceable septum 270. As illustrated, this pierceable septum 270 is positioned between a distal end portion of the second inner body 230 and an inner surface defined by the needle hub of the main outer body 210.

The holding chamber 280 terminates at an outlet port of the interface 200. This outlet port 290 is preferably centrally located in the needle hub of the interface 200 and assists in maintaining the pierceable seal 270 in a stationary position. As such, when a double ended needle assembly is attached to the needle hub of the interface (such as the double ended needle illustrated in FIG. 6), the output fluid path allows both medicaments to be in fluid communication with the attached needle assembly.

The hub interface 200 further comprises a second inner body 230. As can be seen from FIG. 9, this second inner body 230 has an upper surface that defines a recess, and the valve seal 260 is positioned within this recess. Therefore, when the interface 200 is assembled as shown in FIG. 9, the second inner body 230 will be positioned between a distal end of the outer body 210 and the first inner body 220. Together, second inner body 230 and the main outer body hold the septum 270 in place. The distal end of the inner body 230 may also form a cavity or holding chamber that can be configured to be fluid communication with both the first groove 264 and the second groove 266 of the valve seal.

Axially sliding the main outer body 210 over the distal end of the drug delivery device attaches the dispense interface 200 to the multi-use device. In this manner, a fluid communication may be created between the first needle 240 and the second needle 250 with the primary medicament of the first cartridge and the secondary medicament of the second cartridge, respectively.

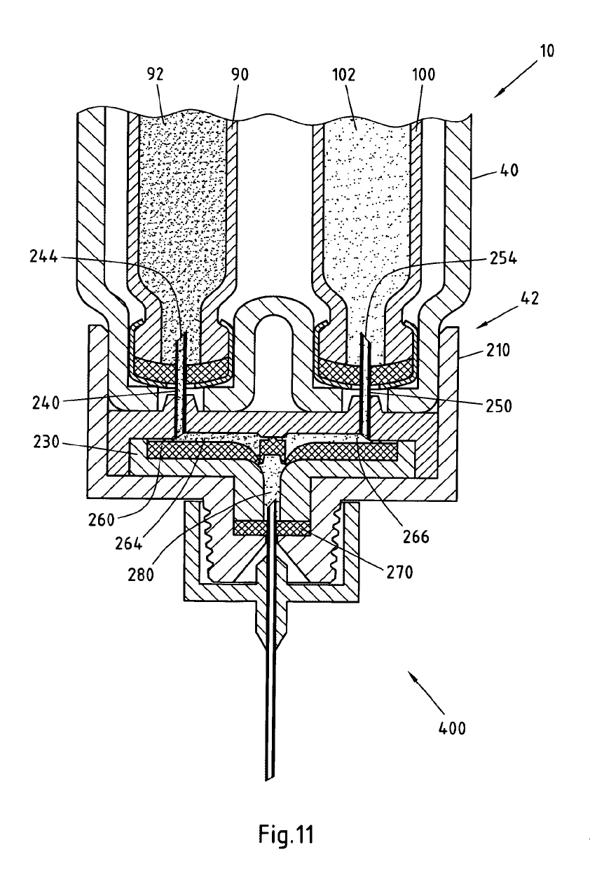

FIG. 11 illustrates the dispense interface 200 after it has been mounted onto the distal end 42 of the cartridge holder 40 of the drug delivery device 10 illustrated in FIG. 1. A double ended needle 400 is also mounted to the distal end of this interface. The cartridge holder 40 is illustrated as having a first cartridge containing a first medicament and a second cartridge containing a second medicament.

When the interface 200 is first mounted over the distal end of the cartridge holder 40, the proximal piercing end 244 of the first piercing needle 240 pierces the septum of the first cartridge 90 and thereby resides in fluid communication with the primary medicament 92 of the first cartridge 90. A distal end of the first piercing needle 240 will also be in fluid communication with a first fluid path groove 264 defined by the valve seal 260.

Similarly, the proximal piercing end 254 of the second piercing needle 250 pierces the septum of the second cartridge 100 and thereby resides in fluid communication with the secondary medicament 102 of the second cartridge 100. A distal end of this second piercing needle 250 will also be in fluid communication with a second fluid path groove 266 defined by the valve seal 260.

FIG. 11 illustrates a preferred arrangement of such a dispense interface 200 that is coupled to a distal end 15 of the main body 14 of drug delivery device 10. Preferably, such a dispense interface 200 is removably coupled to the cartridge holder 40 of the drug delivery device 10.

As illustrated in FIG. 11, the dispense interface 200 is coupled to the distal end of a cartridge housing 40. This cartridge holder 40 is illustrated as containing the first cartridge 90 containing the primary medicament 92 and the second cartridge 100 containing the secondary medicament 102. Once coupled to the cartridge housing 40, the dispense interface 200 essentially provides a mechanism for providing a fluid communication path from the first and second cartridges 90, 100 to the common holding chamber 280. This holding chamber 280 is illustrated as being in fluid communication with a dose dispenser. Here, as illustrated, this dose dispenser comprises the double ended needle assembly 400. As illustrated, the proximal end of the double ended needle assembly is in fluid communication with the chamber 280.

In one preferred arrangement, the dispense interface is configured so that it attaches to the main body in only one orientation, that is it is fitted only one way round. As such as illustrated in FIG. 11, once the dispense interface 200 is attached to the cartridge holder 40, the primary needle 240 can only be used for fluid communication with the primary medicament 92 of the first cartridge 90 and the interface 200 would be prevented from being reattached to the holder 40 so that the primary needle 240 could now be used for fluid communication with the secondary medicament 102 of the second cartridge 100. Such a one way around connecting mechanism may help to reduce potential cross contamination between the two medicaments 92 and 102.

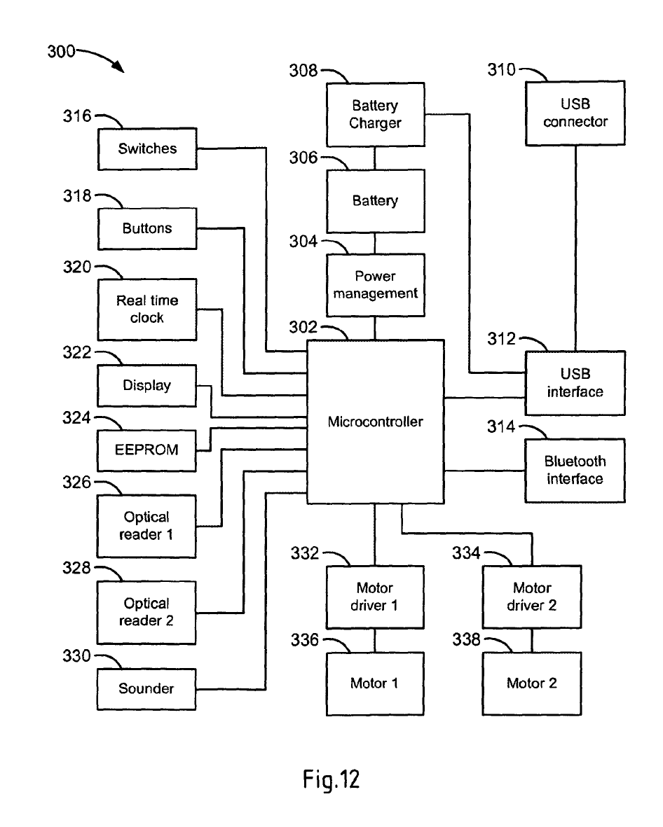

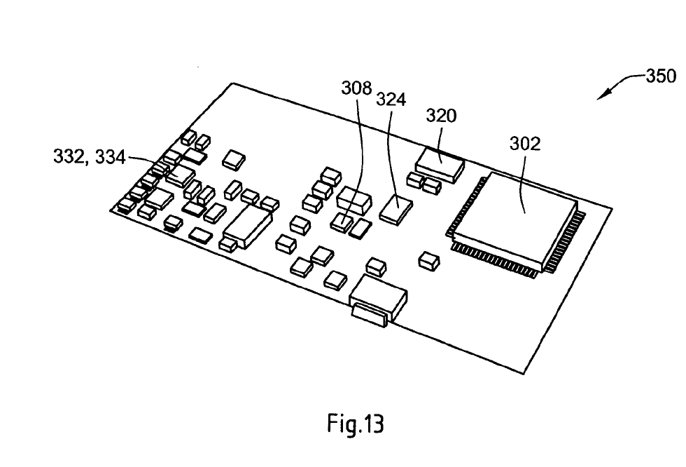

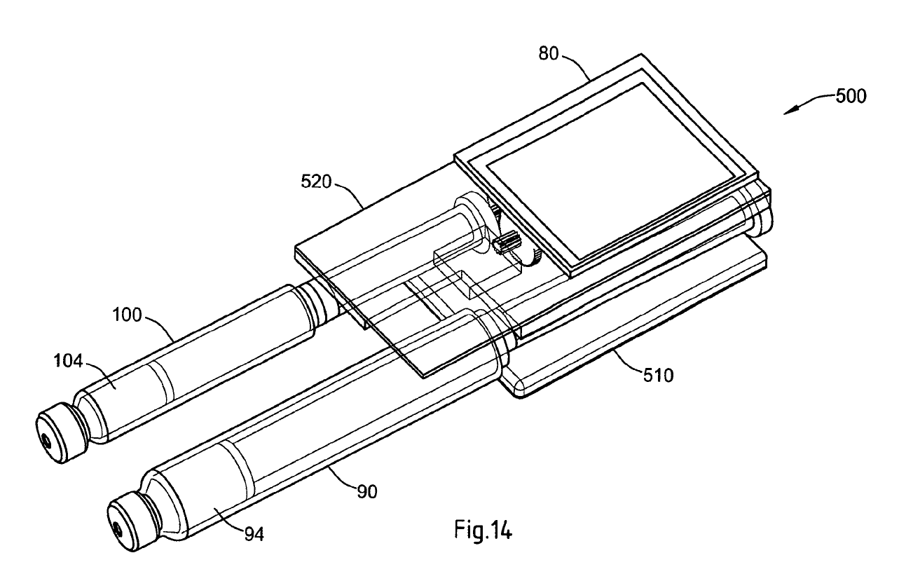

FIG. 12 illustrates a functional block diagram of a control unit to operate and control the drug delivery device illustrated in FIG. 1. FIG. 13 illustrates one arrangement of a printed circuit board (PCB) or printed circuit board assembly (PCBA) 350 that may comprise certain portions of the control unit illustrated in FIG. 12.

Referring now to both FIGS. 12 and 13, it may be seen that the control unit 300 comprises a microcontroller 302. Such a microcontroller may comprise a Freescale MCF51JM microcontroller. The microcontroller is used to control the electronic system for the drug delivery device 10. It includes internal analogue to digital converters and general purpose digital I/O lines. It can output digital Pulse Width Modulated (PWM) signals. It includes an internal USB module. In one arrangement, a USB protection circuit such as ON-Semi NUP3115 may be implemented. In such an implementation, the actual USB communications may be provided on board the microcontroller 302.

The control unit further comprises a power management module 304 coupled to the microcontroller 302 and other circuit elements. The power management module 304 receives a supply voltage from a main power source such as the battery 306 and regulates this supply voltage to a plurality of voltages required by other circuit components of the control unit 300. In one preferred control unit arrangement, switched mode regulation (by means of a National Semiconductor LM2735) is used to step up the battery voltage to 6V, with linear regulation to generate other supply voltages required by the control unit 300.

The battery 306 provides power to the control unit 300 and is preferably supplied by a single lithium-ion or lithium-polymer cell. This cell may be encapsulated in a battery pack that contains safety circuitry to protect against overheating, overcharging and excessive discharge. The battery pack may also optionally contain coulomb counting technology to obtain an improved estimate of remaining battery charge.

A battery charger 308 may be coupled to the battery 306. One such battery charger may be based on Freescale Semiconductor MC34675 along with other supporting software and hardware modules. In one preferred arrangement, the battery charger 308 takes energy from the external wired connection to the drug delivery device 10 and uses it to charge the battery 306. The battery charger 308 can also be used to monitor the battery voltage and charge current to control battery charging. The battery charger 308 can also be configured to have bidirectional communications with the microcontroller 302 over a serial bus. The charge status of the battery 306 may be communicated to the microcontroller 302 as well. The charge current of the battery charger may also be set by the microcontroller 302.

The control unit may also comprise a USB connector 310. A custom design of connector may be used for wired communications and to supply power to the device.

The control unit may also comprise a USB interface 312. This interface 312 may be external to the microcontroller 302. The USB interface 312 may have USB master and/or USB device capability. The USB interface 312 may also provide USB on-the-go functionality. The USB interface 312 external to the microcontroller also provides transient voltage suppression on the data lines and VBUS line.

An external Bluetooth interface 314 may also be provided. The Bluetooth interface 314 is preferably external to the microcontroller 302 and communicates with this controller 302 using a data interface.

Preferably, the control unit further comprises a plurality of switches 316. In the illustrated arrangement, the control unit 300 may comprise eight switches 316 and these switches may be distributed around the device. These switches 316 may be used to detect and or confirm at least the following:

a. Whether the dispense interface 200 has been properly attached to the drug delivery device 10;

b. Whether the removable cap 18 has been properly attached to the main body 20 of the drug delivery device 10;

c. Whether the first cartridge retainer 50 of the cartridge holder 40 for the first cartridge 90 has been properly closed;

d. Whether the second cartridge retainer 52 of the cartridge holder 40 for the second cartridge 100 has been properly closed;

e. To detect the presence of the first cartridge 90;

f. To detect the presence of the second cartridge 100;

g. To determine the position of the stopper 94 in the first cartridge 90; and

h. To determine the position of the stopper 104 in the second cartridge 100.

These switches 316 are connected to digital inputs, for example to general purpose digital inputs, on the microcontroller 302. Preferably, these digital inputs may be multiplexed in order to reduce the number of input lines required. Interrupt lines may also be used appropriately on the microcontroller 302 so as to ensure timely response to changes in switch status.

In addition, and as described in greater detail above, the control unit may also be operatively coupled to a plurality of human interface elements or push buttons 318. In one preferred arrangement, the control unit 300 comprises eight push buttons 318 and these are used on the device for user input for the following functions:

a. Dose dial up;

b. Dose dial down;

c. Sound level;

d. Dose;

e. Eject;

f. Prime;

g. Back button; and

h. OK.

These buttons 318 are connected to digital inputs, for example to general purpose digital inputs, on the microcontroller. Again, these digital inputs may be multiplexed so as to reduce the number of input lines required. Interrupt lines will be used appropriately on the microcontroller to ensure timely response to changes in switch status. In an example embodiment, the function of one or more buttons may be replaced by a touch screen.

In addition, the control unit 300 comprises a real time clock 320. Such a real time clock may comprise an Epson RX4045 SA. The real-time clock 320 may communicate with the microcontroller 302 using a serial peripheral interface or similar.

A digital display module 322 in the device preferably uses LCD or OLED technology and provides a visual signal to the user. The display module incorporates the display itself and a display driver integrated circuit. This circuit communicates with the microcontroller 302 using a serial peripheral interface or parallel bus.

The control unit 300 also comprises a memory device, for example volatile and non-volatile memory. Volatile memory may be random access memory (RAM), for example static RAM or dynamic RAM and/or the like, as working memory of microcontroller 302. Non-volatile memory may be read only memory (ROM), FLASH memory or electrically erasable programmable read-only memory (EEPROM), such as an EEPROM 324. Such an EEPROM may comprise an ON Semiconductor CAT25128. The EEPROM may be used to store system parameters and history data. This memory device 324 communicates with the processor 302 using a serial peripheral interface bus.

The control unit 300 further comprises a first and a second optical reader 326, 328. Such optical readers may comprise Avago ADNS3550. These optical readers 326, 328 may be optional for the drug delivery device 10 and are, as described above, used to read information from a cartridge when such a cartridge is inserted into either the first or the second cartridge retainers 50, 52. Preferably, a first optical reader is dedicated for the first cartridge and the second optical reader is dedicated for the second cartridge. An integrated circuit designed for use in optical computer mice may be used to illuminate a static 2D barcode on the drug cartridge, positioned using a mechanical feature on the drug cartridge, and read the data it contains. This integrated circuit may communicate with the microcontroller 302 using a serial peripheral interface bus. Such a circuit may be activated and deactivated by the microcontroller 302 e.g., to reduce power consumption when the circuit is not needed, for example by extinguishing the cartridge illumination when data is not being read.

As previously mentioned, a sounder 330 may also be provided in the drug delivery device 10. Such a sounder may comprise a Star Micronics MZT03A. Applicants' proposed sounder may be used to provide an audible signal to the user. The sounder 330 may be driven by a pulse-width modulation (PWM) output from the microcontroller 302. In an alternative configuration, the sounder may play polyphonic tones or jingles and play stored voice commands and prompts to assist the user in operating or retrieving information from the device.

The control unit 300 further comprises a first motor driver 332 and a second motor driver 334. The motor drive circuitry may comprise Freescale MPC17533 and is controlled by the microcontroller 302. For example, where the motor drive comprises a stepper motor drive, the drive may be controlled using general purpose digital outputs. Alternatively, where the motor drive comprises a brushless DC motor drive, the drive may be controlled using a Pulse Width Modulated (PWM) digital output. These signals control a power stage, which switches current through the motor windings. The power stage requires continuous electrical commutation. This may for example increase device safety, decreasing the probability of erroneous drug delivery.

The power stage may consist of a dual H-bridge per stepper motor, or three half-bridges per brushless DC motor. These may be implemented using either discrete semiconductor parts or monolithic integrated circuits.

The control unit 300 further comprises a first and a second motor 336, 338, respectively. As explained in greater detail below, the first motor 336 may be used to move the stopper 94 in the first cartridge 90. Similarly, the second motor 338 may be used to move the stopper 104 in the second cartridge. The motors can be stepper motors, brushless DC motors, or any other type of electric motor. The type of motor may determine the type of motor drive circuit used. The electronics for the device may be implemented with one main, rigid printed circuit board assembly, potentially with additional smaller flexible sections as required, e.g., for connection to motor windings and switches.

The microcontroller provided on the PCBA 350 will be programmed to provide a number of features and carry out a number of calculations. For example, and perhaps most importantly, the micro-processor will be programmed with an algorithm for using a certain therapeutic dose profile to calculate at least a dose of the secondary medicament based at least in part on the selected dose of the primary medicament.

For such a calculation, the controller may also analyze other variables or dosing characteristics in calculating the amount of second medicament to administer. For example, other considerations could include at least one or more of the following characteristics or factors:

a. Time since last dose;

b. Size of last dose;

c. Size of current dose;

d. Current blood glucose level;

e. Blood glucose history;

f. Maximum and/or minimum permissible dose size;

g. Time of day;

h. Patient's state of health;

i. Exercise taken; and

j. Food intake.

These parameters may also be used to calculate the size of both the first and the second dose size

In one arrangement, and as will be described in greater detail below, a plurality of different therapeutic dose profiles may be stored in the memory device or devices operatively coupled to the micro-processor. In an alternative arrangement, only a single therapeutic dose profile is stored in the memory device operatively coupled to the micro-processor.

The presently proposed electromechanical drug delivery device is of particular benefit to patients with dexterity or computational difficulties. With such a programmable device, the single input and associated stored predefined therapeutic profile removes the need for the user or patient to calculate their prescribed dose every time they use the device. In addition, the single input allows easier dose setting and dispensing of the combined compounds.

In addition to computing the dose of the second medicament, the micro-processor can be programmed to achieve a number of other device control operations. For example, the micro-processor may be programmed so as to monitor the device and shut down the various elements of the system to save electrical energy when the device is not in use. In addition, the controller can be programmed to monitor the amount of electrical energy remaining in the battery 306. In one preferred arrangement, an amount of charge remaining in the battery can be indicated on the digital display 80 and a warning may be given to the user when the amount of remaining battery charge reaches a predetermined threshold level. In addition, the device may include a mechanism for determining whether there is sufficient power available in the battery 306 to deliver the next dose, or it will automatically prevent that dose from being dispensed. For example, such a monitoring circuit may check the battery voltage under different load conditions to predict the likelihood of the dose being completed. In a preferred configuration the motor in an energized (but not moving) condition and a not energized condition may be used to determine or estimate the charge of the battery.

Preferably, the drug delivery device 10 is configured to communicate via a data link (i.e., either wirelessly or hard wired) with various computing devices, such as a desktop or laptop computer. For example, the device may comprise a Universal Serial Bus (USB) for communicating with a PC or other devices. Such a data link may provide a number of advantages. For example, such a data link may be used to allow certain dose history information to be interrogated by a user. Such a data link could also be used by a health care professional to modify certain key dose setting parameters such as maximum and minimum doses, a certain therapeutic profile, etc. The device may also comprise a wireless data link, for example an IRDA data link or a Bluetooth data link.

In an example embodiment, the device has USB On-The-Go (USB OTG) capability. USB OTG may allow the drug delivery device 10 to generally fulfill the role of being slave to a USB host (e.g., to a desktop or notebook computer) and to become the host themselves when paired with another slave device (e.g. a BGM).

For example, standard USB uses a master/slave architecture. A USB Host acts as the protocol master, and a USB ‘Device’ acts as the slave. Only the Host can schedule the configuration and data transfers over the link. The Devices cannot initiate data transfers, they only respond to requests given by a host. Use of OTG in Applicants' drug delivery device 10 introduces the concept that the drug delivery device can switch between the master and slave roles. With USB OTG, Applicants' device 10 at one time be a ‘Host’ (acting as the link master) and a ‘Peripheral’ (acting as the link slave) at another time.

FIG. 14 illustrates various internal components of the drug delivery device 10 illustrated in FIG. 1 including one preferred arrangement of a drive train 500. As illustrated, FIG. 14 illustrates the digital display 80, a printed circuit board assembly (PCBA) 520 (such as the PCB 350 illustrated in FIG. 13), along with a power source or battery 510. The PCBA 520 may be positioned between the digital display 80 and a drive train 500 with the battery or power source 510 positioned beneath this drive train. The battery or power source 510 is electronically connected to provide power to the digital display 80, the PCBA 520 and the drive train 500. As illustrated, both the first and second cartridges 90, 100 are shown in an expended state. That is, the first and second cartridges are illustrated in an empty state having a stopper at a most distal position. For example, the first cartridge 90 (which ordinarily contains the first medicament 92) is illustrated as having its stopper 94 in the distal position. The stopper 104 of the second cartridge 100 (ordinarily containing the second medicament 102) is illustrated in a similar position.

With reference to FIG. 14, it may be seen that there is provided a first region defining a suitable location for a power source 510 such as a replaceable battery or batteries. The power source 510 may comprise a rechargeable power source and may be recharged while the power source 510 remains in the device. Alternatively, the power source 510 may be removed from the drug delivery device 10 and recharged externally, for example, by way of a remote battery charger. This power source may comprise a Lithium-Ion or Lithium-polymer power source. In this preferred arrangement, the battery 510 comprises a generally flat and rectangular shaped power source.

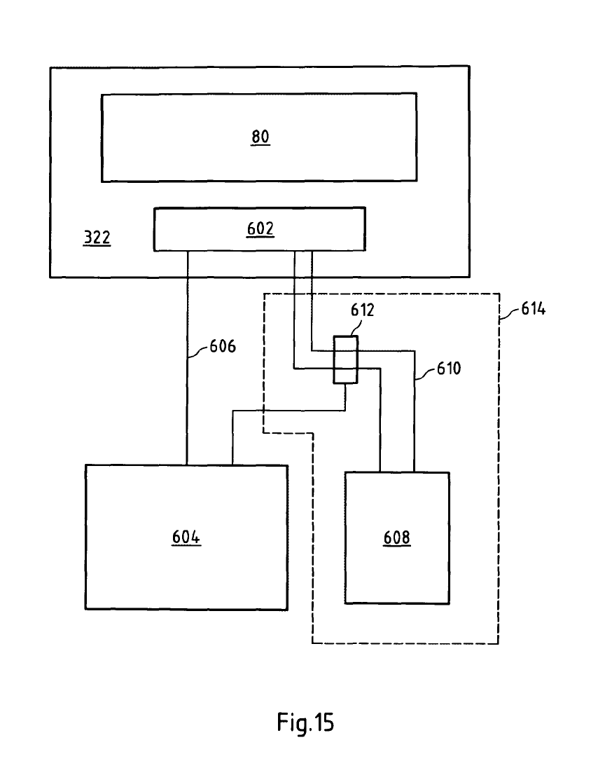

With reference to FIG. 15, there is illustrated an arrangement according to the present invention for testing a digital display module 322 as shown in FIG. 12 comprising a digital display 80 as shown in FIG. 14 of a drug delivery device as illustrated in FIG. 1.

The operation of the digital display module 322 is to be tested. This testing may occur before or after assembly of the drug delivery device, before shipping, before sales by a retailer or during storage or operation by a user. The digital display module 322 under test comprises the digital display 80 proper, which is controlled by a display driver 602 also comprised by the digital display module 322. The digital display 80 may in particular be a liquid crystal display (LCD), a light emitting diode (LED) display, or an organic light emitting diode (OLED) display.

A microcontroller 604 is in electronic contact with the digital display module 322 via a data interface 606. The data interface 606 may be a serial bus or a parallel bus. In particular, the data interface 606 may be a serial peripheral interface bus or an inter-integrated circuit (I2C) bus. The microcontroller 604 may be a microcontroller external to the drug delivery device, or it may be a microcontroller of the drug delivery device, either in normal operation of running a test routine after assembly of the drug delivery device. The microcontroller also implements other functionalities of the drug delivery device in its operation proper. In particular, the microcontroller 604 may be identical to the microcontroller 302 illustrated in FIG. 12 and FIG. 13. In its capacity for testing the digital display, the microcontroller 604 may also be denoted as test control unit 604.

The digital display module 322 is powered via the display driver 602 by a DC voltage provided by a battery 608. The DC voltage is supplied by at least two power supply lines 610. The battery 608 may be the internal battery of the drug delivery device. Alternatively, it may be an external battery 608 specifically connected to the digital display module 322 for testing the digital display module 322.

The microcontroller 604 is further connected to a measuring unit 612 with which it can measure both the voltage of the at least two power supply lines 610 as well as the current supplied through the at least two power supply lines 610. The ensemble of microcontroller 604, battery 408 and measuring unit 612 may also be denoted as an electrical input output arrangement.

The microcontroller 604 runs a program to test the functionality of the digital display module 322 as described in the following: If necessary, the digital display module is activated by an appropriate command sent over the data interface 606.

Subsequently, display data applied to the display during normal operation or specific test display data is written to specific addresses of the digital display driver 602 via the data interface. This display data may for example be graphic bitmap data.

In general, each address in a memory of the digital display driver 602 corresponds to the display state of one or more pixels of the digital display 80. By writing a specific value to these addresses, the appropriate pixels are set to particular colours—or to an “on” or “off” state for monochrome displays—and optionally to a particular luminosity or other appropriate parameters. For example, there may be a bit associated with each pixel which, when set, sets that pixel to a blinking state with a particular frequency. There may also be data written to addresses of the digital display driver 602 which does not set parameters of individual pixels but of the digital display 80 globally, such as the background illumination of the digital display 80.

The test display data may be either predetermined display data or randomly generated display data. The data to be written to the digital display driver 602 may also be operational display data at least as part of the drug delivery device's normal operation. After having written the display data to the digital display driver 602, the microcontroller 604 reads data from the same addresses to which the display data was written.

The digital interface 606 may be such that by means of an acknowledgment signal or by some other way, the success of a write or read access to the digital display driver 602 is signalled to the accessing entity, i.e. the microcontroller 604. Therefore a failed read operation on the addresses just written at this point would already indicate to the microcontroller a malfunction of the digital display module 322.

If the read operation as such was successful, the microcontroller 604 compares the data just read to the display data written before. If the data read is not identical to the data written, this also indicates a malfunction of the digital display module 322.

This cycle of writing display data or test display data to the digital display driver 602, then reading it again and comparing the data written and the data read may be repeated several times with different sets of display data. There may be either several sets of prepared test display data, where each set of test display data is meant to cover specific kinds of errors (bits stuck to 1 or 0, bit shifts within bytes, address shifts etc.) or randomized test display data may be generated for each iteration as the test procedure is run. The cycle may also be repeated several times with normal operational display data. Whether this operational display data is the same from one cycle to the next or different depends on the currently ongoing operation of the drug delivery device.

Alternative or cumulative to the evaluation of the data read back from the digital display driver 402, the microcontroller 604 detects the voltage on the plurality of power supply lines 610 by means of the measuring unit 612. If the voltage detected is not within a specified region, a malfunction is detected. It may either be that the battery 608—if it is an internal battery of the device—is not properly connected to the digital display driver 602. It may also be that there is a short circuit somewhere within the circuitry of the digital display module 322 which pulls the voltage on the plurality of the power supply lines 610 down to a level below specification.

The microcontroller 604 may further detect the current supplied to the digital display module 322 by measuring the current supplied via the plurality of power supply lines 610 from the battery 608. The microcontroller 604 may then determine whether the measured current is within a specified region. The current region may be specified by providing a threshold value below or above which the measured current is expected. The region may also be specified by providing a current range defined by a lower limit and an upper limit of a measured current. If the current is not within the specified region, i.e. above or below the threshold or within the current range, the microcontroller 604 detects a malfunction of the digital display module 322.

Either the threshold value for the measured current or the current range defined by a lower limit and an upper limit may also be calculated by the microcontroller 604 based on the display data written to the digital display driver 602. This is based on the rationale that the power consumption of the digital display module 322 depends on the current state of the display 80. For example, activating a large number of pixels will consume more power than activating a small number of pixels. Setting the activated pixels to a higher luminosity will consume more power than a lower luminosity. In a colour display 80, some colours may consume more power than others. Finally the activation status and luminosity of a background illumination of the display 80 will affect the power consumption of the digital display module 322.

Therefore the microcontroller 604 may dynamically calculate either the aforementioned current threshold or the current range from the display data written to the digital display driver 602. This may be based on a specific algorithm taking the display data as input and may be repeated for each iteration of writing the display data. When the display data is predetermined, likewise the calculation of the threshold or of the range may be implemented offline and thereby outside the microcontroller 604. When the measured current is not within the region specified by the threshold or the range, a malfunction is detected.

The term “drug” or “medicament”, as used herein, means a pharmaceutical formulation containing at least one pharmaceutically active compound,

wherein in one embodiment the pharmaceutically active compound has a molecular weight up to 1500 Da and/or is a peptide, a proteine, a polysaccharide, a vaccine, a DNA, a RNA, an enzyme, an antibody or a fragment thereof, a hormone or an oligonucleotide, or a mixture of the above-mentioned pharmaceutically active compound,

wherein in a further embodiment the pharmaceutically active compound is useful for the treatment and/or prophylaxis of diabetes mellitus or complications associated with diabetes mellitus such as diabetic retinopathy, thromboembolism disorders such as deep vein or pulmonary thromboembolism, acute coronary syndrome (ACS), angina, myocardial infarction, cancer, macular degeneration, inflammation, hay fever, atherosclerosis and/or rheumatoid arthritis,

wherein in a further embodiment the pharmaceutically active compound comprises at least one peptide for the treatment and/or prophylaxis of diabetes mellitus or complications associated with diabetes mellitus such as diabetic retinopathy,

wherein in a further embodiment the pharmaceutically active compound comprises at least one human insulin or a human insulin analogue or derivative, glucagon-like peptide (GLP-1) or an analogue or derivative thereof, or exedin-3 or exedin-4 or an analogue or derivative of exedin-3 or exedin-4.

Insulin analogues are for example Gly(A21), Arg(B31), Arg(B32) human insulin; Lys(B3), Glu(B29) human insulin; Lys(B28), Pro(B29) human insulin; Asp(B28) human insulin; human insulin, wherein proline in position B28 is replaced by Asp, Lys, Leu, Val or Ala and wherein in position B29 Lys may be replaced by Pro; Ala(B26) human insulin; Des(B28-B30) human insulin; Des(B27) human insulin and Des(B30) human insulin.

Insulin derivates are for example B29-N-myristoyl-des(B30) human insulin; B29-N-palmitoyl-des(B30) human insulin; B29-N-myristoyl human insulin; B29-N-palmitoyl human insulin; B28-N-myristoyl LysB28ProB29 human insulin; B28-N-palmitoyl-LysB28ProB29 human insulin; B30-N-myristoyl-ThrB29LysB30 human insulin; B30-N-palmitoyl-ThrB29LysB30 human insulin; B29-N—(N-palmitoyl-Y-glutamyl)-des(B30) human insulin; B29-N—(N-lithocholyl-Y-glutamyl)-des(B30) human insulin; B29-N-(ω-carboxyheptadecanoyl)-des(B30) human insulin and B29-N-(ω-carboxyhepta [symbol] decanoyl) human insulin.

Exendin-4 for example means Exendin-4(1-39), a peptide of the sequence H His-Gly-Glu-Gly-Thr-Phe-Thr-Ser-Asp-Leu-Ser-Lys-Gln-Met-Glu-Glu-Glu-Ala-Val-Arg-Leu-Phe-Ile-Glu-Trp-Leu-Lys-Asn-Gly-Gly-Pro-Ser-Ser-Gly-Ala-Pro-Pro-Pro-Ser-NH2.

Exendin-4 derivatives are for example selected from the following list of compounds:
H-(Lys)4-des Pro36, des Pro37 Exendin-4(1-39)-NH2,
H-(Lys)5-des Pro36, des Pro37 Exendin-4(1-39) NH2,
des Pro36 [Asp28] Exendin-4(1-39),
des Pro36 [IsoAsp28] Exendin-4(1-39),
des Pro36 [Met(O)14, Asp28] Exendin-4(1-39),
des Pro36 [Met(O)14, IsoAsp28] Exendin-4(1-39),
des Pro36 [Trp(O2)25, Asp28] Exendin-4(1-39),
des Pro36 [Trp(O2)25, IsoAsp28] Exendin-4(1-39),
des Pro36 [Met(O)14 Trp(O2)25, Asp28] Exendin-4(1-39),
des Pro36 [Met(O)14 Trp(O2)25, IsoAsp28] Exendin-4(1-39); or
des Pro36 [Asp28] Exendin-4(1-39),
des Pro36 [IsoAsp28] Exendin-4(1-39),
des Pro36 [Met(O)14, Asp28] Exendin-4(1-39),
des Pro36 [Met(O)14, IsoAsp28] Exendin-4(1-39),
des Pro36 [Trp(O2)25, Asp28] Exendin-4(1-39),
des Pro36 [Trp(O2)25, IsoAsp28] Exendin-4(1-39),
des Pro36 [Met(O)14 Trp(O2)25, Asp28] Exendin-4(1-39),
des Pro36 [Met(O)14 Trp(O2)25, IsoAsp28] Exendin-4(1-39),
wherein the group -Lys6-NH2 may be bound to the C-terminus of the Exendin-4 derivative;
or an Exendin-4 derivative of the sequence
H-(Lys)6-des Pro36 [Asp28] Exendin-4(1-39)-Lys6-NH2,
des Asp28 Pro36, Pro37, Pro38Exendin-4(1-39)-NH2,
H-(Lys)6-des Pro36, Pro38 [Asp28] Exendin-4(1-39)-NH2,
H-Asn-(Glu)5des Pro36, Pro37, Pro38 [Asp28] Exendin-4(1-39)-NH2,
des Pro36, Pro37, Pro38 [Asp28] Exendin-4(1-39)-(Lys)6-NH2,
H-(Lys)6-des Pro36, Pro37, Pro38 [Asp28] Exendin-4(1-39)-(Lys)6-NH2,
H-Asn-(Glu)5-des Pro36, Pro37, Pro38 [Asp28] Exendin-4(1-39)-(Lys)6-NH2,
H-(Lys)6-des Pro36 [Trp(O2)25, Asp28] Exendin-4(1-39)-Lys6-NH2,
H-des Asp28 Pro36, Pro37, Pro38 [Trp(O2)25] Exendin-4(1-39)-NH2,
H-(Lys)6-des Pro36, Pro37, Pro38 [Trp(O2)25, Asp28] Exendin-4(1-39)-NH2,
H-Asn-(Glu)5-des Pro36, Pro37, Pro38 [Trp(O2)25, Asp28] Exendin-4(1-39)-NH2,
des Pro36, Pro37, Pro38 [Trp(O2)25, Asp28] Exendin-4(1-39)-(Lys)6-NH2,
H-(Lys)6-des Pro36, Pro37, Pro38 [Trp(O2)25, Asp28] Exendin-4(1-39)-(Lys)6-NH2,
H-Asn-(Glu)5-des Pro36, Pro37, Pro38 [Trp(O2)25, Asp28] Exendin-4(1-39)-(Lys)6-NH2,
H-(Lys)6-des Pro36 [Met(O)14, Asp28] Exendin-4(1-39)-Lys6-NH2,
des Met(O)14 Asp28 Pro36, Pro37, Pro38 Exendin-4(1-39)-NH2,
H-(Lys)6-desPro36, Pro37, Pro38 [Met(O)14, Asp28] Exendin-4(1-39)-NH2,
H-Asn-(Glu)5-des Pro36, Pro37, Pro38 [Met(O)14, Asp28] Exendin-4(1-39)-NH2,
des Pro36, Pro37, Pro38 [Met(O)14, Asp28] Exendin-4(1-39)-(Lys)6-NH2,
H-(Lys)6-des Pro36, Pro37, Pro38 [Met(O)14, Asp28] Exendin-4(1-39)-(Lys)6-NH2,
H-Asn-(Glu)5 des Pro36, Pro37, Pro38 [Met(O)14, Asp28] Exendin-4(1-39)-(Lys)6-NH2,
H-Lys6-des Pro36 [Met(O)14, Trp(O2)25, Asp28] Exendin-4(1-39)-Lys6-NH2,
H-des Asp28 Pro36, Pro37, Pro38 [Met(O)14, Trp(O2)25] Exendin-4(1-39)-NH2,
H-(Lys)6-des Pro36, Pro37, Pro38 [Met(O)14, Asp28] Exendin-4(1-39)-NH2,
H-Asn-(Glu)5-des Pro36, Pro37, Pro38 [Met(O)14, Trp(O2)25, Asp28] Exendin-4(1-39)-NH2,
des Pro36, Pro37, Pro38 [Met(O)14, Trp(O2)25, Asp28] Exendin-4(1-39)-(Lys)6-NH2,
H-(Lys)6-des Pro36, Pro37, Pro38 [Met(O)14, Trp(O2)25, Asp28] Exendin-4(S1-39)-(Lys)6-NH2,
H-Asn-(Glu)5-des Pro36, Pro37, Pro38 [Met(O)14, Trp(O2)25, Asp28] Exendin-4(1-39)-(Lys)6-NH2;
or a pharmaceutically acceptable salt or solvate of any one of the afore-mentioned Exedin-4 derivative.

Hormones are for example hypophysis hormones or hypothalamus hormones or regulatory active peptides and their antagonists as listed in Rote Liste, ed. 2008, Chapter 50, such as Gonadotropine (Follitropin, Lutropin, Choriongonadotropin, Menotropin), Somatropine (Somatropin), Desmopressin, Terlipressin, Gonadorelin, Triptorelin, Leuprorelin, Buserelin, Nafarelin, Goserelin.

A polysaccharide is for example a glucosaminoglycane, a hyaluronic acid, a heparin, a low molecular weight heparin or an ultra low molecular weight heparin or a derivative thereof, or a sulphated, e.g. a poly-sulphated form of the above-mentioned polysaccharides, and/or a pharmaceutically acceptable salt thereof. An example of a pharmaceutically acceptable salt of a poly-sulphated low molecular weight heparin is enoxaparin sodium.

Antibodies are globular plasma proteins (18 150 kDa) that are also known as immunoglobulins which share a basic structure. As they have sugar chains added to amino acid residues, they are glycoproteins. The basic functional unit of each antibody is an immunoglobulin (Ig) monomer (containing only one Ig unit); secreted antibodies can also be dimeric with two Ig units as with IgA, tetrameric with four Ig units like teleost fish IgM, or pentameric with five Ig units, like mammalian IgM.

The Ig monomer is a “Y”-shaped molecule that consists of four polypeptide chains; two identical heavy chains and two identical light chains connected by disulfide bonds between cysteine residues. Each heavy chain is about 440 amino acids long; each light chain is about 220 amino acids long. Heavy and light chains each contain intrachain disulfide bonds which stabilize their folding. Each chain is composed of structural domains called Ig domains. These domains contain about 70-110 amino acids and are classified into different categories (for example, variable or V, and constant or C) according to their size and function. They have a characteristic immunoglobulin fold in which two β sheets create a “sandwich” shape, held together by interactions between conserved cysteines and other charged amino acids.

There are five types of mammalian Ig heavy chain denoted by α, δ, ε, γ, and μ. The type of heavy chain present defines the isotype of antibody; these chains are found in IgA, IgD, IgE, IgG, and IgM antibodies, respectively.

Distinct heavy chains differ in size and composition; α and γ contain approximately 450 amino acids and δ approximately 500 amino acids, while μ and ε have approximately 550 amino acids. Each heavy chain has two regions, the constant region (CH) and the variable region (VH). In one species, the constant region is essentially identical in all antibodies of the same isotype, but differs in antibodies of different isotypes. Heavy chains γ, α and δ have a constant region composed of three tandem Ig domains, and a hinge region for added flexibility; heavy chains μ and ε have a constant region composed of four immunoglobulin domains. The variable region of the heavy chain differs in antibodies produced by different B cells, but is the same for all antibodies produced by a single B cell or B cell clone. The variable region of each heavy chain is approximately 110 amino acids long and is composed of a single Ig domain.

In mammals, there are two types of immunoglobulin light chain denoted by λ and κ. A light chain has two successive domains: one constant domain (CL) and one variable domain (VL). The approximate length of a light chain is 211 to 217 amino acids. Each antibody contains two light chains that are always identical; only one type of light chain, κ or λ, is present per antibody in mammals.

Although the general structure of all antibodies is very similar, the unique property of a given antibody is determined by the variable (V) regions, as detailed above. More specifically, variable loops, three each the light (VL) and three on the heavy (VH) chain, are responsible for binding to the antigen, i.e. for its antigen specificity. These loops are referred to as the Complementarity Determining Regions (CDRs). Because CDRs from both VH and VL domains contribute to the antigen-binding site, it is the combination of the heavy and the light chains, and not either alone, that determines the final antigen specificity.

An “antibody fragment” contains at least one antigen binding fragment as defined above, and exhibits essentially the same function and specificity as the complete antibody of which the fragment is derived from. Limited proteolytic digestion with papain cleaves the Ig prototype into three fragments. Two identical amino terminal fragments, each containing one entire L chain and about half an H chain, are the antigen binding fragments (Fab). The third fragment, similar in size but containing the carboxyl terminal half of both heavy chains with their interchain disulfide bond, is the crystallizable fragment (Fc). The Fc contains carbohydrates, complement-binding, and FcR-binding sites. Limited pepsin digestion yields a single F(ab′)2 fragment containing both Fab pieces and the hinge region, including the H—H interchain disulfide bond. F(ab′)2 is divalent for antigen binding. The disulfide bond of F(ab′)2 may be cleaved in order to obtain Fab′. Moreover, the variable regions of the heavy and light chains can be fused together to form a single chain variable fragment (scFv).

Pharmaceutically acceptable salts are for example acid addition salts and basic salts. Acid addition salts are e.g. HCl or HBr salts. Basic salts are e.g. salts having a cation selected from alkali or alkaline, e.g. Na+, or K+, or Ca2+, or an ammonium ion N+(R1)(R2)(R3)(R4), wherein R1 to R4 independently of each other mean: hydrogen, an optionally substituted C1 C6-alkyl group, an optionally substituted C2-C6-alkenyl group, an optionally substituted C6-C10-aryl group, or an optionally substituted C6-C10-heteroaryl group. Further examples of pharmaceutically acceptable salts are described in “Remington's Pharmaceutical Sciences” 17. ed. Alfonso R. Gennaro (Ed.), Mark Publishing Company, Easton, Pa., U.S.A., 1985 and in Encyclopedia of Pharmaceutical Technology.

Pharmaceutically acceptable solvates are for example hydrates.

1-9. (canceled)

10. A method comprising:
applying a voltage to a digital display module;
detecting an electrical quantity related to the digital display module; and
determining whether the detected electrical quantity is indicative of correct operation of the digital display module,
wherein detecting an electrical quantity related to the digital display module comprises detecting a current supplied to the display driver,
wherein determining whether the detected electrical quantity is indicative of correct operation of the digital display module comprises determining whether the detected current is indicative of correct display driver operation,
wherein applying a voltage to the digital display module comprises writing a set of display data into a display driver of the digital display module to at least one predetermined address,
wherein determining whether the detected current is indicative of correct display driver operation comprises comparing the detected current with a current threshold, which current threshold is based on the display data.

11. The method of claim 10, wherein:
applying a voltage to the digital display module comprises writing a set of display data into a display driver of the digital display module to at least one predetermined address;
detecting an electrical quantity related to the digital display module comprises reading data out of the display driver from the at least one predetermined address; and
determining whether the detected electrical quantity is indicative of correct operation of the digital display module comprises determining whether reading the data out of the display driver was successful and determining whether the data read out of the display driver is identical to the display data written into the display driver.

12. The method of claim 10, wherein:
detecting an electrical quantity related to the digital display module comprises detecting a voltage level on at least one power supply line of a display driver of the digital display module; and
determining whether the detected electrical quantity is indicative of correct operation of the digital display module comprises determining whether the detected voltage level is below a voltage threshold.

13. The method of claim 10, wherein the display data is test display data, which is predetermined display data or randomly generated display data.

14. The method of claim 13, wherein, determining whether the detected current is indicative of correct display driver operation comprises comparing the detected current with a current threshold, which current threshold is based on the test display data.

15. The method of claim 13, wherein, determining whether the detected current is indicative of correct display driver operation comprises comparing the detected current with a current range, which current range is based on the test display data.

16. A system for interfacing to a digital display, comprising an electrical input output arrangement configured to
apply a voltage to a digital display module;
detect an electrical quantity related to the digital display module; and
determine whether the detected electrical quantity is indicative of correct operation of the digital display module,
wherein the electrical input output arrangement comprises:
a battery configured to supply a voltage on at least one power supply line of a display driver of the digital display module;
a measuring unit configured to detect a current supplied to the display driver; and
a test control unit configured to determine whether the detected current is indicative of correct display driver operation,
wherein the test control unit is a microcontroller configured to run a program to test the functionality of the digital display module according to the method of claim 10.

17. The system of claim 16, wherein the electrical input output arrangement comprises a test control unit configured to
write a display data into a display driver of the digital display module to at least one predetermined address;
read data out of the display driver from the at least one predetermined address;
determine whether reading the data out of the display driver was successful; and
determine whether the data read out of the display driver is identical to the display data written into the display driver.

18. The system of claim 16, wherein the electrical input output arrangement comprises:
a battery configured to supply a voltage on at least one power supply line of a display driver of the digital display module;
a measuring unit configured to detect a voltage level on the least one power supply line; and
a test control unit configured to determine whether the detected voltage level is below a voltage threshold.
